(19) United States
(12) Patent Application Publication
(10) Pub. No.: US 2010/0275231 A1
(43) Pub. Date: Oct. 28, 2010

(54) ELECTRONIC PROGRAM GUIDE DISPLAYING METHOD

(75) Inventors: CHAE-YONG YI, SEOUL (KR); KYUNG-AH KIM, SEOUL (KR)

Correspondence Address: MAXON IP LLC, 46175 WESTLAKE DR., SUITE 410, POTOMAC FALLS, VA, 20165, US

(73) Assignee: PXD, INC., SEOUL (KR)

(21) Appl. No.: 12/743,587

(22) PCT Filed: Nov. 28, 2008
(86) PCT No.: PCT/KR08/07061

§ 371 Date: May 19, 2010

(30) Foreign Application Priority Data
Nov. 28, 2007 (KR) 10-2007-0122352

(51) Int. Cl. H04N 5/445

(52) U.S. Cl. 725/44; 725/58

(57) ABSTRACT

The present invention relates to an Electronic Program Guide (EPG) display technology. More particularly, the present invention relates to an intuitive and easy-to-use EPG display technology by which TV viewers can recognize the information about the current TV program, the next program and the later programs of a channel at a glance. When a viewer selects an item (CHANNEL MENU in Korean or EPG or GUIDE) of Main Menu, the list of current programs of the channels belonging to the selected menu item appears at the right side of the Main Menu. Only focused channel has the next program information adjacent to the current program, and only when the focus is moved to the next program, the list of later programs displays in order to reduce the information overload and to show exactly what viewers need, in the present invention. According to the present invention, viewers may easily find current and next programs for a channel, may identify information for previous channel in addition to current channel, which enables quick access for the program viewers want to watch, and may select a later program for recording or reminding by the list of the later programs of the selected channel.

### TECHNICAL FIELD

The present invention relates to an Electronic Program Guide (EPG) display technology. More particularly, the present invention relates to an intuitive and easy-to-use EPG display technology by which TV viewers can recognize the information about the current TV program, the next program and the later programs of a channel at a glance. When a viewer selects an item (CHANNEL MENU in Korean or EPG or GUIDE) of Main Menu, the list of current programs of the channels belonging to the selected menu item appears at the right side of the Main Menu. Only focused channel has the next program information adjacent to the current program, and only when the focus is moved to the next program, the list of later programs displays in order to reduce the information overload and to show exactly what viewers need, in the present invention.

### BACKGROUND ART

The EPG is an application which displays the television schedules on the television screen and provides viewer with the information about a specific program.

FIGS. 1 to 3 illustrate examples of prior art of EPG display.

Referring to FIG. 1, a prior art EPG shows detailed information for the selected current program on upper part, above the program guide. The most of existing electronic program guides show television programs 22 in a grid format (time horizontally and channel rows 21 vertically) mimicking printed program guides. The EPG as shown provides the television schedules for about two hours and a few channels. In order to provide more schedules, the program guide is constructed by small font.

However, most of program titles do not fit into the rectangle and the texts truncated with ellipses hinder viewers from understanding the program title clearly. Further, too many programs in too small size font make it difficult for viewers to find the information they want.

In summary, the prior art EPG has problems that viewers fail to easily navigate the program they want to watch and to identify program titles because of overwhelming amount of information due to the structure of time and channel axes on a television screen.

The prior art EPG has this grid format with horizontal time axis and vertical channel axis. Each channel rows has programs by time, which has problems that the construction is too complicated for viewers to easily identify information. A viewer should go through in horizontal line in order to find following programs for a selected channel, which renders the prior art EPG inconvenient to use.

Further, since the default position of the current channel is the first row (first item) in the on-screen list, it is difficult for viewers not only to know the existence of previous channel, but also to get the information about the previous channel.

That is, in the prior art EPG, in general, the current channel is by default focused on the first row in the on-screen list of EPG. So viewers cannot acquire any information for previous channel in the on-screen list. In order to get the information for a previous channel, viewers should scroll the previous channels in the on-screen list.

Digital set-top boxes or digital TV sets offers a channel banner (called one-line EPG, or mini EPG) which displays the detailed information of current channel and current program. Further, in the prior art EPG, detailed information of channel banner is not always synchronized with the current program on air.

For example, referring to FIG. 2, for 52 MBC ESPN channel, the current program at 15:42 is “2007 BASEBALL” and the next program is “GOOD FRIENDS (RERUN)” which is scheduled to start at 16:00. However, referring to FIG. 3, the program which is actually broadcasted at 8.23 (THU) 15:42 is “GOOD FRIENDS (RERUN)”, which shows an example that prior art EPG wrongly provides current program.

Further, when an advertisement airs between current and next programs, channel banner (one-line EPG or mini EPG) typically shows the information of programs which have already ended.

This is why the next program about to broadcast is also important factor for selecting channel, and it is preferable to further present detailed information for next program as well on EPG or channel banner. However, prior art EPG, existing channel banners offer only detailed information on current program so it cannot satisfy the viewer's need as above.

In order to efficiently utilize screen asset, there have been filed EPG technologies as below.

Korean Publication No. 10-1999-0067564 (‘Presentation-Enhanced EPG’, HYUNDAI Electronics Inc.) discloses a technology in which programs are represented by icons or texts. Japanese Publication No. 2006-203535 (‘EPG Display Device’, SHARP Corp.) discloses a technology in which widths for channel and time for a designated area are extended in EPG. However, these technologies are still typical forms of TV schedule table, where the table is constructed by channel axis and time axis, and therefore still have the problem that program information cannot be easily identified.

Korean Publication No. 10-0323699 (‘EPG User Interface for Display Device’, LG Electronics Inc.) discloses a technology in which EPG is overlaid over video and detailed information is presented in a sub-window. However, this EPG is still typical form of prior art EPG.

Korean Publication No. 10-0693652 (‘Display Device of TV Program Data and Method for the same’, LG Electronics Inc.) discloses a technology in which programs are hierarchically presented in EPG. This technology is newer form of EPG. However, due to the hierarchical nature, the technology has problems that many operations are required for searching for program information and further that it is difficult to search for information for the current program.

Korean Publication No. 10-0425645 (‘EPG Display Method for DTV Device’, ALTICAST Corp.) discloses an EPG in which channel selection in a subtitle lets times and titles for programs in the selected channel are shown. This EPG has problem that it is difficult to display program information for other channels.

### DISCLOSURE

### Technical Problem

The purpose of the present invention is to provide an EPG display technology by which viewers can easily identify current and next programs for the focused channel.

Another purpose of the present invention is to provide an EPG display technology in which the default position of focus in Main Menu is not the first row (item) for a quick menu access.

Another purpose of the present invention is to provide an EPG display technology providing tabbed menu by channel number groups, by category channels and by favorite channels in the main menu.

Another purpose of the present invention is to provide an EPG display technology in which viewers may move to previous channel with identifying information for the previous and next channels, by positioning the current channel in the second row and the previous channel in the first row in the program guide.

Another purpose of the present invention is to provide an EPG display technology in which the row area of the focused channel in the list takes up the margins of above and below neighboring channels so that corresponding text is shown in enlarged form.

Another purpose of the present invention is to provide an EPG display technology in which later programs of the focused channel display in a list form.

Another purpose of the present invention is to provide an EPG display technology in which channel banner has the information of next program as well as current program for the detailed information.

### Technical Solution

The EPG displaying method according to the present invention comprises steps of, (A) displaying Main Menu having at least one channel menu item (EPG or GUIDE menu); (B) positioning focus on one of the channel menu items, moving the focus corresponding to user input, and selecting one channel menu item; (C) displaying current program list for channels of the selected channel menu item by the side of the channel menu item, positioning focus on one of channels of the current program list, extending the focused channel area to neighboring channel areas, and moving the focus channel area corresponding to a focus move event; (D) displaying next program for the focused channel, wherein the next program is displayed by the side of current program of the focused channel; and (E) when one of the current program being selected through focus move events, tuning the selected program.

### Advantageous Effects

According to the present invention, viewers may easily identify the current and next programs for a channel, and may identify information for previous channel in addition to current channel, which enables quick and easy navigation of EPG.

Further, according to the present invention, viewers may concentrate on program information of the selected channel, may easily identify information of current programs for other channels, may simultaneously identify current and next programs for the selected channel, and may easily record or remind later programs by sequentially presenting later program list when the next program is focused.

Further, according to the present invention, when an advertisement is presented between current and next programs or when next program is going to start after current program has ended, correct information is provided to viewers via channel banner including the information of next program as well as current program.

### DESCRIPTION OF DRAWINGS

FIG. 1 illustrates an example of prior art EPG display.

FIG. 2 illustrates other example of prior art EPG display.

FIG. 3 illustrates a screen to be shown when the focused channel in FIG. 2 is selected.

FIG. 4 illustrates an embodiment of EPG display according to the present invention.

FIG. 5 illustrates other embodiment of EPG display according to the present invention.

FIG. 6 illustrates an embodiment of the EPG display method according to the present invention.

FIG. 7 illustrates an embodiment of the EPG display method according to the present invention, wherein a channel banner (one-line EPG or min EPG) including detailed information upon current and next program is shown in the bottom of screen when a specific program is selected to view.

FIG. 8 illustrates an embodiment of the present invention, wherein a main menu is shown in the left of screen.

FIG. 9 illustrates an embodiment of the present invention, wherein a current program list and a next program are displayed when GUIDE menu is selected in FIG. 8.

FIG. 10 illustrates an embodiment of the present invention, wherein a later program list is displayed when the focus moves to the next program in FIG. 9.

FIG. 11 illustrates an embodiment of the present invention, wherein an element is presented in two lines when the element has much to display in FIG. 9.

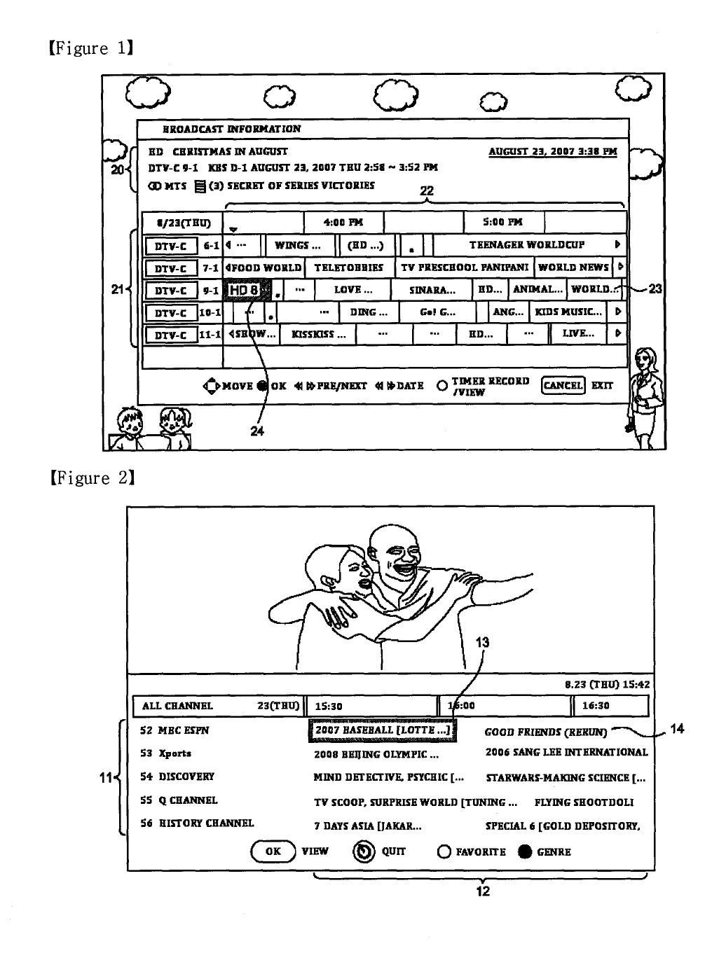

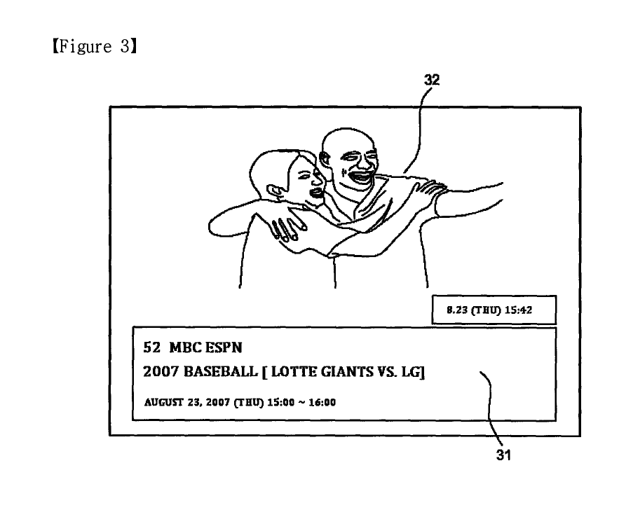

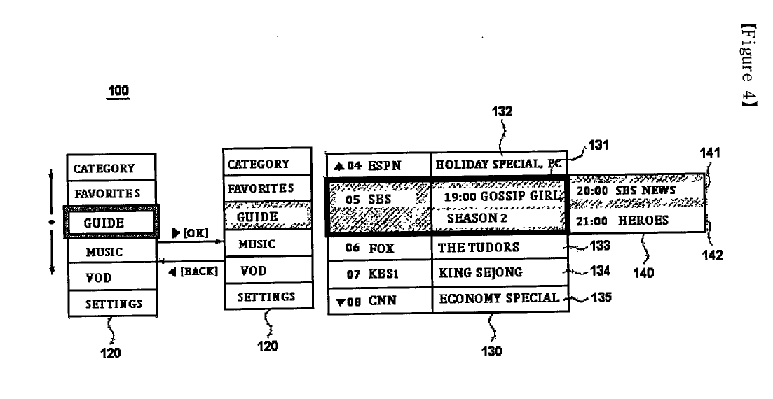

### BEST MODE

Hereinafter, embodiments of the present invention will be described in detail with reference to the accompanying drawings.

FIG. 4 illustrates an embodiment of the EPG display according to the present invention. In the first scene, EPG 100 provides main menu 120 having GUIDE (it can be EPG or CHANNEL MENU) menu, including GUIDE BY CATEGORY CHANNELS (CATEGORY, for a convenience), GUIDE BY FAVORITE CHANNELS (FAVORITES, for a convenience), GUIDE BY MUSIC CHANNELS (MUSIC, for a convenience), VOD (Video On-Demand), and SETTINGS.

In the first scene of EPG 100, default focus is positioned on GUIDE menu which is in the center position of the main menu, not on the first item CATEGORY menu. In the main menu, GUIDE which is the most important function is located in the center position, and the lesser important or lesser frequently used functions are located in the upper or lower adjacent from the center item. It is for an access to other menu items to up and down directions quickly from the center defualt focus with the up and down arrow buttons on a remote control.

FAVORITES menu is preferably located adjacent to GUIDE menu in main menu 120. FAVORITES menu is a GUIDE by users' favorite channels. By locating FAVORITES menu adjacent to GUIDE menu, viewers may easily and quickly access the FAVORITES menu.

When a GUIDE menu is selected in main menu 120, it shows current program list of some channels 130 and one or two next programs of the focused channel 140. In FIG. 4, it is shown that the focused channel 131 is “05 SBS” and its current program is “GOSSIP GIRL SEASON2” which starts at “19:00”.

Presentation of the row area of focused channel in the current program list 130 takes up the margins of above and below adjacent channels. If the program title is long, the title is presented in two lines, and short program title is presented in a single line. For the case of two line presentation, the focused channel area takes up to area of the neighboring channels partially. The unfocused channels 132, 133, 134, 135 are represented in a single line.

It is shown the current program 131 of the focused channel and the next program 140 of the focused channel (SBS) is also presented by the right side of the current program. In FIG. 4, it is shown that next program of “05 SBS” channel is “20:00 SBS NEWS” 141. The next program, which is going to broadcast after current program, is located on the first row on next program list 140, followed by the next program “21:00 HOT DRAMA” 142. One or two next programs may be presented by the right side of current program of the focused channel.

That is, for a focused channel, area of current program extends for more detailed information, and one or two next programs are presented by the right side of the current program. When the focus is moved to the next program, later programs are displayed in a list form.

In the EPG 100 according to the present embodiment, by presenting more detailed information of the current program and the next program together for only the focused channel, not showing all the next programs of channels, viewers can simply look guide information and easily navigate EPG 100.

In the current program list 130, focus is positioned by default on the channel which being watched when EPG 100 is activated. Further, it is preferable that the focused channel is located by default on the second row in the current program list 130. By positioning default focus on the second row and further positioning in the first row previous channel, viewers may easily get the information for the previous channel “04 ESPN” in the illustration.

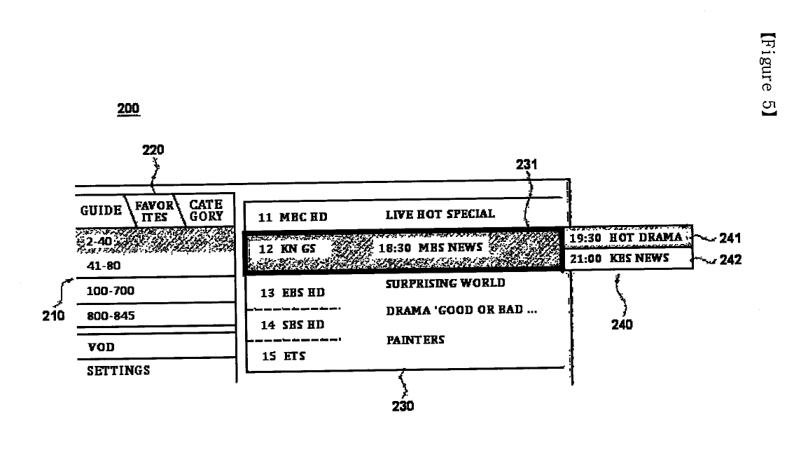

FIG. 5 illustrates other embodiment of the EPG display according to the present invention.

In EPG 200, main menu 210 forms main menu with the tabbed form for GUIDE menu, FAVORITES menu, CATEGORY menu. Main menu 210 further forms taps for VOD and SETTINGS. The GUIDE menu organize all channels by channel numbers into four groups (2-40, 41-80, 100-700, 800-845), by which viewers may easily identify channel map for all channels at a glance, and quickly access the channel which viewers want.

The channel numbers in main menu 210 may be grouped by broadcast operators, set-top box manufacturers, television manufacturers or users for their convenience. In the EPG 200 of the present embodiment, main menu 210 comprises groups of broadcasting channel numbers and all the channels including video channels, music (audio) channels and PPV (Pay-Per-View) channels, are listed by channel number, by which viewers can quickly access any channel number group.

In the present embodiment, VOD (Video On-Demand) and SETTINGS, which are not requiring radio frequency, separately form menues at the bottom of the main menu. Horizontal tabbed menu 220 on the main menu 210 have FAVORITES menu and CATEGORY menu in addition to GUIDE menu, by which viewers may easily use the present EPG.

To the right of main menu 210, there is provided current program list 230 where current programs for channels of the focused channel number group (2-40) are listed. Further to the right of the focused channel 231, there is provided next program 240 including one or two next programs 241, 242.

Among the features of current program list 230, the features of extending focused channel to neighboring area, enlarging font size of the focused channel and positioning default focus and the current watching channel on the second item in the current program list may be similarly adopted.

The EPG 200 provides on the initial screen channels of a predetermined channel number groups, and lets viewers easily and quickly access a channel via channel grouping.

When the next program (140 in FIG. 4, 240 in FIG. 5) is selected, that is, when users move the focus to the next program 140, 240 of EPG 100, 200, more later programs of the focused channel are displayed in a list form, which shall be described in detail below.

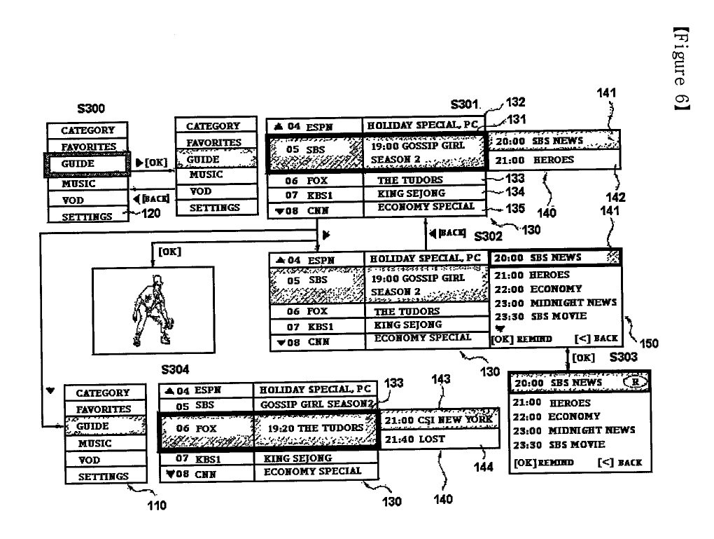

FIG. 6 illustrates an embodiment of the EPG display method according to the present invention, and FIGS. 8 to 11 illustrate implemented images for the embodiment.

First, main menu 120 is displayed if MENU button on the remote control is pressed. Menu item can be selected by moving the focus with four arrow-buttons and [OK] button on the remote control or extra buttons in TV sets or set-top boxes.

When a GUIDE (EPG or CHANNEL MENU) menu, in FIG. 6, is selected in the main menu, then, current program list is displayed by the right side of the selected menu. The graphic image of the current program list may be presented on a TV screen with translucency.

In the current program list, current channel is positioned in the second item and the focus moves to the second item (i.e. current channel) of the list from the GUIDE menu. Default focus is initially set into the second item (current channel) in the current program list. It is because viewers may recognise previous channel of the current channel which is positioned in the first item in the list. In the current program list 130, the activated row by the focus extends to neighboring rows, preferably to bottom blank of upper row and to top blank of lower row, by which text of the focused row may be clearly presented to viewers. Long program title is presented in two lines, and short program title is presented in a single line. However, in either case, it is preferable that the extended area remains in same.

In FIG. 6, the focused channel 131 is “05 SBS HD”, and the current program title “GOSSIP GIRL SEASON2” and its start time of current program are clearly presented.

Only focused channel has its next program 141 and it is presented to the right side of the current program 131 (S301). Next program, when being unfocused, it may be set to one 141 or two 141, 142 or more of next programs of the current program.

When the currently focused program 131 is selected with [OK] button on the remote control, the corresponding channel frequency is tuned and viewers can watch the selected channel. When focus moves to the right, that is next program 141 from the currently focused program 131, later programs 150 of the focused channel are sequentially presented (S302). In FIG. 6, a list of four later programs is presented below the next program 141.

The functions of remind and record a later program may be further provided in later program list 150. For example, by pressing [OK] REMIND button in FIG. 6, the program may be scheduled to view (S303).

When [<] BACK button of future program list 150 or left arrow button of remote control is pressed, the later program list disappears and TV screen returns to previous form where current program list 130 and next program are shown together.

When focus is moved to “06 FOX” channel 133, as described above with referring to (S301), the activated row extends to neighboring rows, by which text of the focused channel 133 may be clearly presented. Further, next program 140 is presented by the right side of the focused channel 133 (S304), in which the next program 140 shows one 143 or two 143, 144 of next programs of the currently focused channel 133.

The present EPG displaying method, can be used easily and intuitively. It is minimized information by presenting only necessary information when viewers need it, but also maximized the efficiency of using EPG on a TV screen.

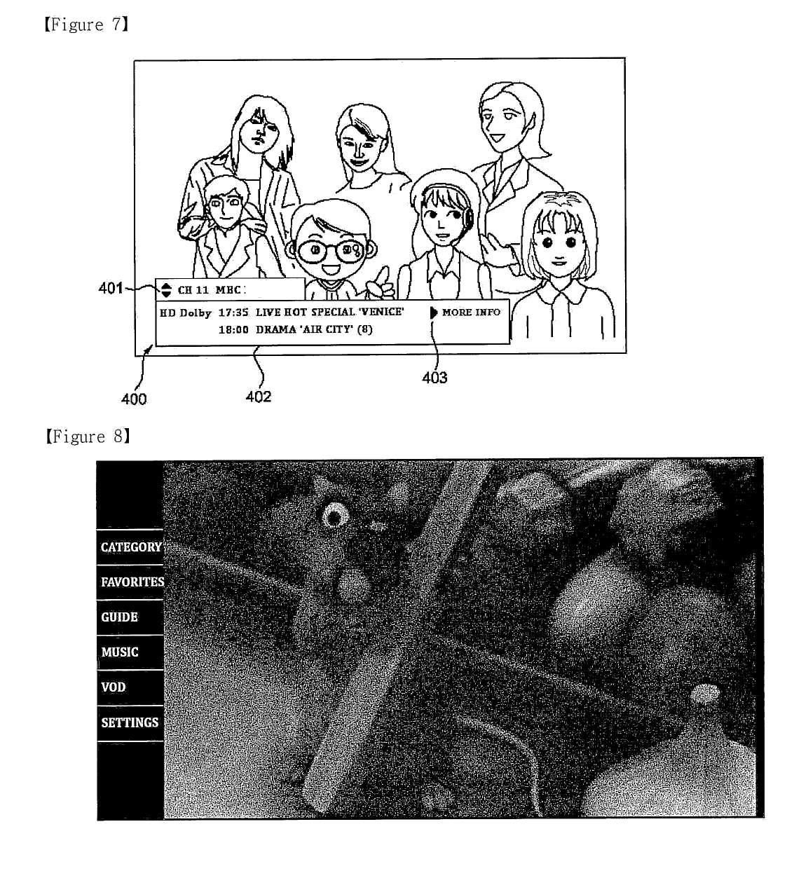

FIG. 7 illustrates an embodiment of the EPG display method according to the present invention, wherein a channel banner including detailed information upon current and next programs is shown in the lower area of the on-screen while watching TV shows.

Channel banner 400 is shown on lower area of TV on-screen. Channel name (CH11 MBC) is provided in the upper part. In the lower part, there is detailed information of the current program such as video quality (HD), audio information (Dolby), start time of current program (17:35), the current program title (LIVE HOT SPECIAL ‘VENICE’), start time of next program (18:00), and the next program title (DRAMA ‘AIR CITY (8)’).

Most of prior art channel banners presents detailed information for current program only, when a predetermined button of a remote control is pressed, such as [OK], [ENTER] or [DETAILED INFORMATION] buttons. However, sometimes, detailed information in the channel banner does not match with the TV program showing now. It may happen when, for example, an advertisement or next program is broadcasting after current program ended.

Further, because the next program which is about to start is also important in selecting channel, it is preferable to further present detailed information of next program in addition to current program. Therefore, by providing next and current programs on channel banner, viewers can get the correct information without any confusion.

The up and down arrow icons 401 shown in left to channel name (CH11 MBC) are provided for browsing other channels. Preferably, the upper arrow lets channel numbers increase, e.g., channel 12, 13, 14, and the lower arrow lets channel numbers decrease, e.g., 10, 9, 8. In case of channel browsing in the channel banner with up and down arrow buttons on the remote control, the channel banner is updated, but channel frequency is not tuned. In case of pressing [CHANNEL UP] and [CHANNEL DOWN] buttons on the remote control, the channel banner is updated and also the channel is tuned and changed. The channel banner may be presented for 5 seconds by default, which is not essential to the present invention.

By changing information of EPG in channel banner without tuning, viewers may get the correct information of another program of neighbor channels in addition to that of current channel program.

FIGS. 8 to 11 illustrate actual rendering images where EPG display according to the present invention is implemented. Because most of detailed description is provided above, only brief description for the figures is presented below.

FIG. 8 illustrates an embodiment of the present invention, wherein a main menu is shown in the left of screen. When viewers press MENU button on the remote control during watching TV, as shown in FIG. 8, slim main menu is presented in the left side of on-screen so that the main menu does not interrupt TV screen.

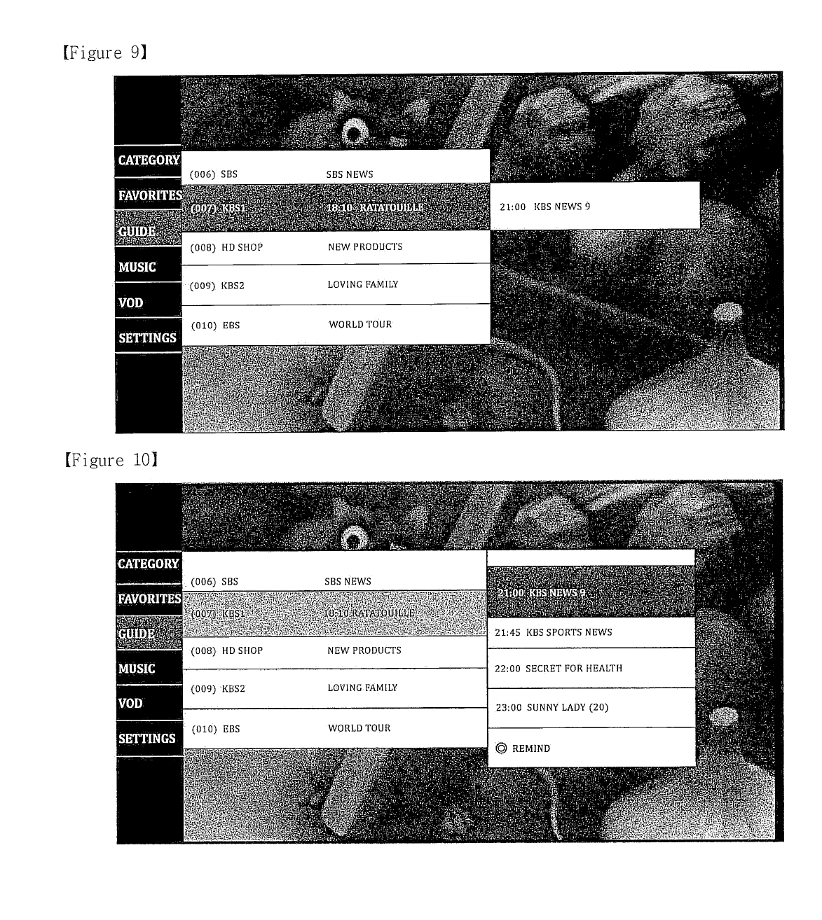

FIG. 9 illustrates an embodiment of the present invention, wherein a current program list and a next program are displayed when GUIDE is selected in FIG. 8. When viewers select GUIDE menu, current program list of some channels and the next program of the focused channel is presented. The current channel and its current program, i.e, “RATATOUILLE” of channel KBS1 is focused with its start time. Further, next program of “KBS NEWS 9” with its start time 21:00 is also presented in its right side.

FIG. 10 illustrates an embodiment of the present invention, wherein a later program list is displayed when the focus moves to the next program in FIG. 9. When viewers move the focus to “KBS NEWS 9” which is next program of “RATATOUILLE”, “KBS NEWS 9” is focused and at the same time, a list of later programs is displayed. Remind or record functions are provided in this list.

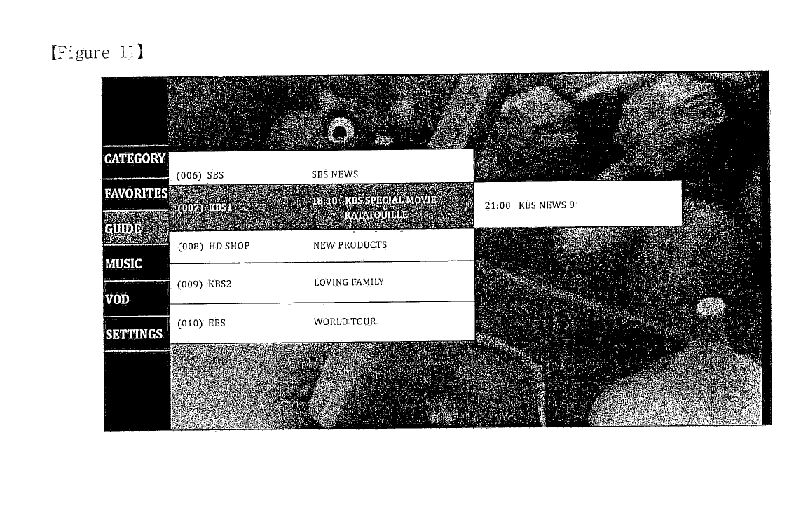

FIG. 11 illustrates an embodiment of the present invention, wherein the program title is presented in two lines when the title is long in FIG. 9. That is, when the focused current program is “KBS SPECIAL MOVIE RATATOUILLE”, the current program title is long for one line. In that case, the current program is presented in two lines.

1. An EPG displaying method, comprising steps of,
(A) displaying a main menu, wherein said main menu includes more than one channel menu items (EPG or GUIDE menu);
(B) positioning focus on one of said channel menu items, moving said focus corresponding to user input, and selecting one channel menu item;
(C) displaying current program list for channels of said selected channel menu item by the side of said channel menu item, positioning focus on one of channels of said current program list, extending said focused channel area to margins of neighboring channel areas, and moving said focus channel area corresponding to a focus move event;
(D) displaying next program for said focused channel, wherein said next program is displayed by the side of current program of said focused channel; and
(E) when one of said current program being selected through focus move events, tuing said selected program.

2. The method according to claim 1, wherein:
said step (D) comprises steps of:
(D-1) displaying, for said focused channel in said current program list, either a next program or some of next programs with said current program;
(D-2) when said focus is moved from said current program to said next program, sequentially displaying later program list by expanding the number of said next program; and
(D-3) recovering display of said focused channel area in said current program list, and positioning focus on said current program.

3. The according to claim 2, wherein:
said step (A) comprises steps of:
(A-1) forming tabbed menu for said more than one channel menu items in said main menu; and
(A-2) when one item of said tabbed menu is selected by user input, displaying lower level channel menu items on said main menu, wherein said lower level channel menu item is formed by multiple groups of channels grouped by channel numbers of said selected channel menu.

4. The method according to claim 3, wherein:
said step (A-2) comprises step of displaying said lower level channel menu item through grouped channels of said selected channel menu by channel numbers and making a row of the selected element.

5. The method according to one of claims 1 to 4, wherein:
said step (C) comprises, out of said current channel list, presenting unfocused channel item having the space of single line and, said focused channel item having the space for upto two lines, and then displaying detailed information of said channel's current program in said focused channel item without changing the position or the size of the above or below channel and program title in order to reduce viewers' confusion.

6. The method according to one of claims 1 to 4, wherein:
said step (A) comprises:
displaying said main menu by positioning a plurality of menu items including said channel menu items vertically contiguously, and the most important item is positioned at the center position of menu and the other items are positioned upper or lower adjacent from the center item; and
positioning default focus on said center position.

7. The method according to one of claims 1 to 4, wherein:
said step (C) comprises forming said current program list by positioning current channel and default focus on the second row and positioning the previous channel of said focused current channel on the first row.

8. The method according to one of claims 1 to 4, wherein:
said step (E) further comprises displaying channel banner or mini EPG on the bottom area of TV on-screen, wherein said channel banner includes detailed information including more than one of current channel information, current program title, start time of current program, next program title and start time of next program.

9. The method according to one of claims 1 to 4, further comprising a step of reminding or recording the next program which is selected out of said next programs in a later program list through focus move events.
